(19) United States
(12) Patent Application Publication
(10) Pub. No.: US 2023/0021335 A1
(43) Pub. Date: Jan. 26, 2023

(54) METHOD FOR DETERMINING ADDITIVE MANUFACTURING PARAMETERS

(71) Applicant: AddUp, Cebazat (FR)

(72) Inventors: ALEXIS PICARD, CEBAZAT (FR); ANTHONY AUBRUN, Cebazat (FR); MICHEL RUIZ, Cebazat (FR)

(21) Appl. No.: 17/778,166

(22) PCT Filed: Nov. 17, 2020
(86) PCT No.: PCT/FR2020/052101

§ 371 Date: May 19, 2022

(30) Foreign Application Priority Data
Nov. 19, 2019 (FR) 1912875

(51) Int. Cl. B29C 64/386; B29C 64/153; B29C 64/40; B29C 64/268

(52) U.S. Cl. CPC B29C 64/386; B29C 64/153; B29C 64/40; B29C 64/268; B33Y 10/00

(57) ABSTRACT

A method for determining additive manufacturing parameters for the manufacture of an additive manufacturing support (1) for a target part exhibiting an overhang comprises the steps of: (a) additive manufacture of a plurality of supports for each supporting an overhang (2) of a test part (3), each support (1) being associated with a collection of manufacturing parameters and a collection of geometric parameters pertaining to the overhang (2); (b) manufacturing the test part (3) and observing, for each support (1), a collection of mechanical parameters pertaining to the support (1); (c) determining the additive manufacturing parameters for the manufacture of the support (1) of the target part on the basis of the geometric parameters pertaining to the overhang of the target part and of the mechanical parameters pertaining to the support.

### FIELD OF THE INVENTION

The present invention relates to the field of additive manufacturing and more particularly of the additive manufacturing of parts having an overhang.

### PRIOR ART

In a known manner, additive manufacturing consists in manufacturing a part by successive superposition of layers of powder that are locally consolidated, for example by melting.

More specifically, additive manufacturing by powder bed deposition consists in creating three-dimensional objects by consolidating selected zones in successive layers of pulverulent material (metal powder, ceramic powder, polymer powder, etc.). The consolidated zones correspond to successive cross sections of the three-dimensional object. Consolidation takes place for example layer by layer, for example through total or partial selective melting carried out using a consolidation source (a high-power laser beam, an electron beam, etc.).

This manufacturing method makes it possible to produce structures that are impossible to manufacture with traditional methods (machining, moulding).

In particular, additive manufacturing makes it possible to produce parts having tapers and undercuts, which may occasionally have concave or convex geometric shapes, which are difficult to produce by moulding and by machining.

Additive manufacturing also makes it possible to produce latticework structures that cannot be manufactured any other way.

In addition, this manufacturing method can prove to be rapid and relatively inexpensive, and this allows it to be used in the context of rapid prototyping, instead of, for example, high-speed machining, which remains complex.

In additive manufacturing, the part is produced by successively stacking layers. Depending on the orientation of the part and the geometry thereof, it is sometimes necessary to start the manufacture by producing a support on which the part is manufactured. In the case in which the part includes an overhang, that is to say a part extending unsupported beyond the rest of the part, it is necessary to provide a support under this overhang.

The support manufactured needs to be firm enough to support the overhang without breaking or bending, while being quick to manufacture. Specifically, in additive manufacturing, the manufacturing cycles may be relatively lengthy and it is therefore imperative not to waste time on elements, such as the supports, which do not form part of the end-product. In additive manufacturing, in order to increase the rate of manufacture, one known lever is to increase the speed of the spot of the beam of the consolidation source in the plane of the layer of powder and the inter-vector space (i.e. the space between two adjacent trajectory portions of the trajectory of the spot of the beam of the consolidation source). Now, these parameters have a direct influence on the density and firmness of the consolidated part.

It is therefore necessary to succeed in combining the antinomic parameters that are, on the one hand, the speed of the spot of the beam of the consolidation source and/or the inter-vector space and, on the other hand, firmness in the manufacture of the supports.

Accordingly, it is an objective of the present invention to provide a method for determining parameters for the additive manufacture of an additive manufacturing support for a part exhibiting an overhang, so as to allow an optimal supporting strategy to be selected.

### SUMMARY OF THE INVENTION

According to a first aspect, the invention proposes a method for determining additive manufacturing parameters for the manufacture of an additive manufacturing support for a target part exhibiting an overhang. The method comprises the steps of:

(a) additive manufacture of a plurality of supports for each supporting an overhang of a test part, each support being associated with a collection of manufacturing parameters and a collection of geometric parameters pertaining to the overhang;

(b) manufacturing said test part and observing, for each support, a collection of mechanical parameters pertaining to the support;

(c) determining said additive manufacturing parameters for the manufacture of said support of said target part on the basis of the geometric parameters pertaining to the overhang of the target part and of the mechanical parameters pertaining to the support.

Particularly advantageously, the method according to the invention makes it possible, before manufacturing a target part, to determine the optimum manufacturing parameters for the overhang or overhangs of the target part. The method according to the invention is all the more advantageous when, in additive manufacturing, the target part is a monobloc assembly. So, since breakage of a support leads to the breakage of an overhang, the breakage of a support damages the entire part and requires the manufacture to be begun again right from the start. The determination method according to the invention highly advantageously allows this kind of problem to be avoided as far as possible by allowing the manufacture of supports that are mechanically suited to the overhangs of the target part that is to be manufactured while still being quick to manufacture.

Thus, the invention proposes a method for determining parameters for the additive manufacture of an additive manufacturing support for a part exhibiting an overhang, so as to allow an optimal supporting strategy to be selected.

The additive manufacturing may be performed by a consolidation source emitting a beam that successively consolidates layers of a pulverulent material, the collection of manufacturing parameters comprising at least one of the following parameters: the composition of the pulverulent material used, the speed of travel of a spot of the beam of the consolidation source and the inter-vector space corresponding to a separation between two vectors of the path of the spot of the beam of the consolidation source.

The additive manufacturing may be performed by a consolidation source emitting a beam that successively consolidates layers of a pulverulent material by total or partial melting.

The collection of mechanical parameters pertaining to the support may comprise at least one of the following parameters: density, porosity, tensile-compressive strength, resistance to buckling, bending strength.

The collection of geometric parameters pertaining to an overhang may comprise at least one of the following parameters: altitude of an overhang, angle of an overhang with respect to a normal to a manufacturing plane, mass of the overhang and surface area of an overhang.

Step (a) comprises the following steps:

(a1) manufacturing, according to a collection of chosen manufacturing parameters, a support for supporting a first overhang of the test part, inclined at a first angle;

(a2) manufacturing, according to the same collection of manufacturing parameters as in step (a1), a second support for supporting a second overhang of the test part, inclined at a second angle different from the first angle;

(a3) repeating the steps (a1) and (a2) n times, where n>0 corresponds to the number of repeats, modifying n times the collection of parameters for the manufacture of the supports.

Step (b) may comprise the manufacture of the test part exhibiting n similar pairs of first and second overhangs.

The collection of geometric parameters pertaining to the overhang for each support manufactured in step (a) may comprise a variation in altitude.

Step (c) may comprise selecting a group of supports comprising at least one support that is neither broken nor bent.

The method may be reiterated, on the basis of the selected group of supports, while varying the collection of geometric parameters pertaining to the overhang and/or the collection of manufacturing parameters pertaining to the supports.

Step (c) may comprise use of an optimization algorithm to select the best support on the basis of a collection of chosen manufacturing parameters and/or of a collection of chosen geometric parameters pertaining to the overhang.

According to another aspect, the invention relates to a method for the additive manufacturing of a support for a part having an overhang, the support being manufactured according to manufacturing parameters determined by a method according to the invention.

### DESCRIPTION OF THE FIGURES

Further features, objects and advantages of the invention will become apparent from the following description, which is purely illustrative and non-limiting and should be read in conjunction with the appended drawing, in which:

FIG. 1 is a schematic depiction of a series of supports and of a test part which have been manufactured according to a first provision of the invention.

FIG. 2 is a schematic depiction of a series of supports and of a test part which have been manufactured according to a second provision of the invention.

### DETAILED DESCRIPTION OF THE INVENTION

According to a first aspect, the invention relates to a method for determining manufacturing parameters pertaining to an additive manufacturing support 1 for a target part exhibiting an overhang 2.

### Principle for the Additive Manufacture of a Target Part Exhibiting an Overhang

It is recalled that additive manufacturing consists in manufacturing a part by successive superposition of layers of powder that are locally consolidated.

More specifically, additive manufacturing by powder bed deposition consists in creating three-dimensional objects by consolidating selected zones in successive layers of pulverulent material (metal powder, ceramic powder, polymer powder, etc.). The consolidated zones correspond to successive cross sections of the three-dimensional object. Consolidation takes place for example layer by layer, for example through total or partial selective melting carried out using a consolidation source (a high-power laser beam, an electron beam, etc.).

In the present document, an additive manufacturing device will be considered to have a manufacturing plane P on which the layers of pulverulent material are spread. Manufacture is performed by stacking the layers of pulverulent material in an axial direction Z normal to the manufacturing plane P.

In other words, manufacturing is performed by stacking layers of ever-increasing altitude with respect to the manufacturing plane P.

For example, a powder bed deposition additive manufacturing device comprises, in a fixed manufacturing chamber:
a movable platform on which the different layers of additive manufacturing powder are successively deposited,
one or more energy beam sources controlled for selectively scanning the powder bed,
a powder supply reservoir,
a tool such as a scraper or a roller, which moves in translation over the platform to spread the powder.

As explained previously, in additive manufacturing, the part is produced by successively stacking layers. Depending on the orientation of the part and the geometry thereof, it is sometimes necessary to start the manufacture by producing a support on which the part is manufactured. In the case in which the part includes an overhang, that is to say a part extending unsupported beyond the rest of the part, it is necessary to provide a support under this overhang.

The support manufactured needs to be firm enough to support the overhang without breaking or bending, while being quick to manufacture. The support is an element purely associated with the manufacturing and is not kept in the target end-product part.

In the present document, a part that is to be manufactured, having its own geometry, is referred to as target part. The manufacture of the target part is the objective of the additive manufacturing method and, before that, of the determination method that forms the subject matter of the invention.

### General Summary of the Method

As stated previously, according to a first aspect, the invention relates to a method for determining additive manufacturing parameters for the manufacture of an additive manufacturing support 1 for a target part exhibiting an overhang.

Thus, as will be detailed hereinafter, the method according to the invention makes it possible to determine parameters that will be used for the manufacture of a support 1 during the manufacture of a target part. The method according to the invention therefore occurs upstream of the manufacture of a target part as such.

As will be described hereinafter, the method involves manufacturing a test part 3; the test part 3 is used only for the determination method and is not kept for the manufacture of the target part.

The method chiefly comprises the following steps:

(a) additive manufacture of a plurality of supports for each supporting an overhang 2 of a test part 3, each support 1 being associated with a collection of manufacturing parameters and a collection of geometric parameters pertaining to the overhang 2;

(b) manufacturing said test part 3 and observing, for each support 1, a collection of mechanical parameters pertaining to the support 1;

(c) determining said additive manufacturing parameters for the manufacture of said support 1 of said target part on the basis of the geometric parameters pertaining to the overhang of the target part and of the mechanical parameters pertaining to the support.

In other words, the method according to the invention consists first of all (step (a)) in manufacturing a series of supports 1 which are each suited to supporting an overhang 2 of a test part 3. The supports are manufactured while varying the manufacturing parameters and/or the geometric parameters pertaining to the overhang 2 of the test part 3.

Specifically, two main collections of input parameters govern the shape and structure of an additive manufacturing support 1. On the one hand, the manufacturing parameters, which will be detailed hereinafter, these parameters being likenable to settings of the manufacturing device. And on the other hand, the parameters pertaining to the geometry of the overhang 2. Specifically, because the support 1 is manufactured to support an overhang 2, its structure is partially dictated by the structure of the overhang 2 that is to be supported. The parameters pertaining to the geometry of the overhang 2 will also be detailed hereinafter. Thus, the method according to the invention consists first of all in manufacturing a series of different supports 1 while varying these two collections of input parameters which are the manufacturing parameters and the parameters pertaining to the geometry of the overhang 2.

In parallel (step (b)), a test part is manufactured. This test part 3 exhibits a series of overhangs 2, each overhang 2 being supported by a support.

After manufacture, step (c) consists in selecting at least one support 1 from among those manufactured.

As will be detailed hereinafter, the selection may be a choice of one single support 1 on a binary criterion of breaking strength. In other words, a support 1 is chosen from among those that have not broken or bent during the manufacture of the overhang. Specifically, most additive manufacturing devices use a roller or a scraper to spread the pulverulent material. As it passes, this roller or scraper applies load to the elements that are in the process of being manufactured. If the support 1 has a structure that is too fragile, it may break or bend under the action of the roller or of the scraper.

The selection may also be more complex and entail several iterations of the determination method.

### Input Parameters

As was explained above, the manufacture of the supports is performed while varying two collections of parameters.

A first collection groups the manufacturing parameters, this collection of parameters notably covering the composition of the pulverulent material used, the speed of travel of the spot of the beam of the consolidation source and the inter-vector space. The inter-vector space corresponding to a separation between two vectors of the path of the spot of the beam of the consolidation source. In other words, the inter-vector space corresponds to the space between two adjacent path portions of the path of the spot of the beam of the consolidation source.

It must be emphasized that what is meant by spot is an area covered by the beam on the manufacturing plane.

Particularly advantageously, varying the speed of the spot of the beam and the inter-vector space makes it possible to vary the volume energy density of the energy delivered by the consolidation source. Specifically, consolidation consists in supplying energy corresponding to a volume energy density determined as follows: [Math. 1]

$$Volume energy density ( J \cdot {cm}^{- 3} ) = \frac{Power ( W )}{S peed ( cm \cdot {s}^{- 1} ) \cdot Inter - vector space ( cm ) \cdot Layer thickness ( cm )}$$

with the speed corresponding to the speed of travel of the spot of the beam of the consolidation source in the plane of the powder, the inter-vector space corresponding to the separation between two vectors of the path of the spot of the beam of the consolidation source in the plane of manufacture and the layer thickness corresponding to the distance separating two consecutive planes on which the pulverulent material is spread.

It is remarkable that varying the volume energy density makes it possible to vary the structure of the material shaped by additive manufacturing.

In other words, by modifying the volume energy density it is possible to have, for example, a structure that is dense, porous and/or lamellar.

A second collection of parameters groups together the parameters pertaining to the geometry of the overhang 2. This collection of parameters notably covers: the altitude of the overhang, an angle of the overhang 2 with respect to the normal Z to the manufacturing plane P, the mass of the overhang and the surface area of the overhang.

It is emphasized that the altitude is preferably expressed in the axial direction Z normal to the manufacturing plane P.

It will be readily appreciated that these parameters particularly influence the structure of the support. Specifically, the altitude of the overhang of the target part dictates the altitude of the support. The angle of the overhang may lead to deformations in the axial direction Z, particularly when this angle is small. This has the effect of reducing the space between the roller and the part and exacerbates the risk of friction. Finally, the mass likewise dictates the loads applied to the support 1 and the surface area will dictate the cross-sectional area of the support 1 parallel to the manufacturing plane P.

### Output Parameters

These are referred to here as output parameters because they are parameters resulting from the choices made for the manufacturing parameters and the geometric parameters of the overhang.

The output parameters of the method are a collection of mechanical parameters pertaining to the support and parameters pertaining to the speed of manufacture of the support.

As explained previously, it is preferable to optimize the speed of manufacture of the support which does not form part of the end-product. As a preference, the collection of mechanical parameters covers at least one of the following parameters: density, porosity, elastic modulus, tensile-compressive strength, resistance to buckling, bending strength. It will be appreciated that the tensile-compressive strength, the resistance to buckling and the bending strength notably dictate the breaking strength (i.e. whether the support 1 is able to withstand the loads associated with manufacture).

Step (a)

As explained hereinabove, step (a) consists first of all in manufacturing a series of different supports 1 while varying these two collections of input parameters which are the manufacturing parameters and the parameters pertaining to the geometry of the overhang.

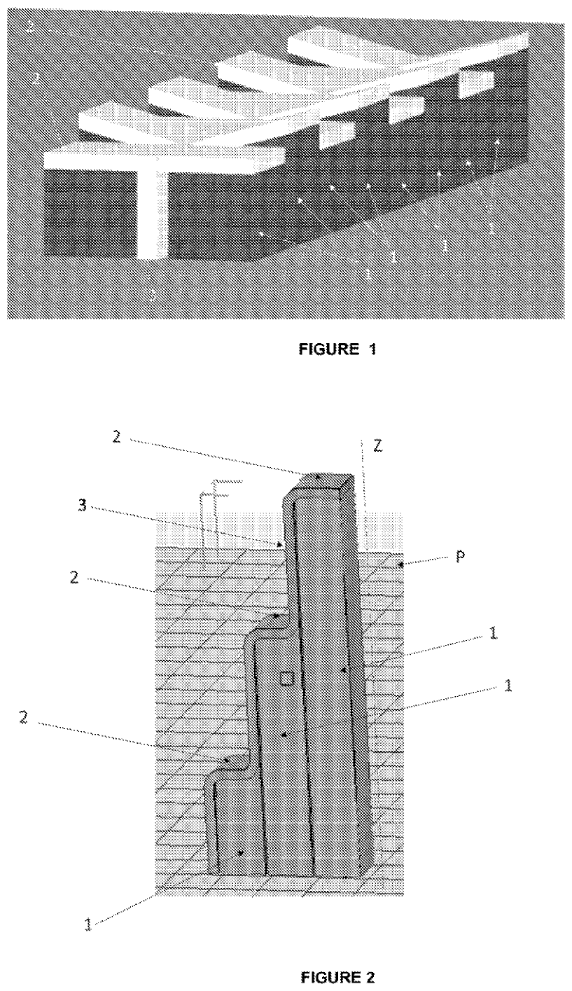

More particularly, according to one particular provision depicted in FIG. 1, step (a) may comprise the following steps:

(a1) manufacturing, according to a collection of chosen manufacturing parameters, a support 1 for supporting a first overhang 2 of the test part 3, inclined at a first angle;

(a2) manufacturing, according to the same collection of manufacturing parameters as in step (a1), a second support 1 for supporting a second overhang 2 of the test part 3, inclined at a second angle different from the first angle;

(a3) repeating the steps (a1) and (a2) n times, where n>0 corresponds to the number of repeats, modifying n times the collection of parameters for the manufacture of the supports.

According to this provision, only the manufacturing parameters and the angle of the overhang can be varied. This provision allows a standardized comparison to be made of the manufacturing parameters.

In other words, according to this provision, it is known that the mass and the altitude of the overhang 2 do not vary. The only parameters that vary, in alternation, are the angle and the manufacturing parameters.

Thus, according to this provision, for each pair of supports 1 manufactured with identical manufacturing parameters, there is a first angle which may be around 90° with respect to the axial direction Z and a second angle that may be comprised between 95° and 120°.

According to another provision depicted in FIG. 2, step (a) may be performed varying only the altitude of the overhang.

As will be described hereinafter, the two provisions set out in FIGS. 1 and 2 can be implemented separately or successively.

Step (b)

According to the provision depicted in FIG. 1, step (b) comprises the manufacture of the test part 3 exhibiting n similar pairs of first and second overhangs.

According to the provision depicted in FIG. 2, step (b) comprises the manufacture of the test part 3 exhibiting a succession of overhangs of different altitudes.

It is notable that, because of the very nature of additive manufacturing methods, steps (a) and (b) begin simultaneously.

Note that several runs of steps (a) and (b) may even be implemented simultaneously or in series. In particular, it is possible to implement a first run wherein two distinct angles of the support 2 are varied, and a second run in which the altitude of the support is varied.

Step (c)

As detailed hereinabove, step (c) consists in determining said additive manufacturing parameters for the manufacture of said support 1 of said target part on the basis of the geometric parameters pertaining to the, or each, overhang of the target part and of the mechanical parameters pertaining to the support. It is emphasized that the overhang 2 of the test part 3 may be identical to an overhang of the target part, but may also be different and exhibit similar estimated characteristics.

The principle behind the method is to look, in the supports 1, for the overhangs 2 of the test part 3 having estimated characteristics that are sufficiently similar to the overhang of the target part that is to be manufactured. An angular discrepancy of around ten degrees and an altitude discrepancy of plus or minus 2 centimetres might for example be tolerated. In other words, if what is to be manufactured is, for example, a target part exhibiting an overhang situated at an altitude of 10 centimetres, supports for overhangs 2 of test parts 3 situated at 3 centimetres will not be considered. By contrast, a selection may be made from among supports 1 for overhangs 2 of test parts 3 that are situated at altitudes comprised between 9 and 11 centimetres.

Typically, step (c) may consist in simply choosing a support 1 that is neither broken nor bent.

According to another provision, step (c) may comprise selecting a group of supports comprising at least one support that is neither broken nor bent.

Next, the method may be reiterated, on the basis of the selected group of supports 1, while varying the collection of geometric parameters pertaining to the overhang 2 of the test part 3 and/or the collection of manufacturing parameters.

Typically, it is for example possible to execute the method according to the provision set out in FIG. 1. And then to select a support 1 and re-execute the method for this support, varying only the altitude of the overhang 2 (FIG. 2). This provision then makes it possible to determine a maximum acceptable altitude for one support type.

In addition, step (c) may comprise use of an optimization algorithm to select the best support 1 on the basis of a collection of chosen manufacturing parameters and/or of a collection of chosen geometric parameters pertaining to the overhang.

Thus, after having executed the method at least once and having selected a group of supports, the use of an optimization algorithm may allow the optimal support 1 to be determined precisely on the basis of a chosen weighting assigned to the input parameters. What is meant by a chosen weighting is an importance, and therefore a mathematical weight, assigned to a certain parameter. Thus, for a given overhang geometry, it may be possible to determine optimum manufacturing parameters for combining speed of manufacture and strength of the support 1.

Particularly advantageously, the method according to the invention makes it possible, before manufacturing a target part, to determine the optimum manufacturing parameters for the overhang or overhangs of the target part. The method according to the invention is all the more advantageous when, in additive manufacturing, the target part is a monobloc assembly. So, since breakage of a support leads to the breakage of an overhang, the breakage of a support damages the entire part and requires the manufacture to be begun again right from the start. The determination method according to the invention highly advantageously allows this kind of problem to be avoided as far as possible by allowing the manufacture of supports 1 that are mechanically suited to the overhangs of the target part that is to be manufactured while still being quick to manufacture.

Advantageously, the determination method is not necessarily implemented prior to each additive manufacturing method. The determination method may enable the construction of a chart allowing the selection of a suitable support for the additive manufacture of several target parts.

### Additive Manufacturing Method

According to another aspect, the invention relates to a method for the additive manufacturing of a support 1 for a part having an overhang, the support 1 being manufactured according to manufacturing parameters determined by a method according to the invention.

Advantageously, the method comprises prior implementation of the method for determining manufacturing parameters according to the invention.

1.-11. (canceled)

12. A method for determining additive manufacturing parameters for manufacture of an additive manufacturing support for a target part exhibiting an overhang, the method comprising the steps of:
(a) additively manufacturing a plurality of supports for each supporting an overhang of a test part, each support being associated with a collection of manufacturing parameters and a collection of geometric parameters pertaining to the overhang, wherein step (a) comprises the following steps:
(a1) manufacturing, according to a collection of chosen manufacturing parameters, a support for supporting a first overhang of the test part, inclined at a first angle,
(a2) manufacturing, according to the collection of manufacturing parameters in step (a1), a second support for supporting a second overhang of the test part, inclined at a second angle different from the first angle, and
(a3) repeating steps (a1) and (a2) n times, where n>0 corresponds to a number of repeats, modifying n times the collection of parameters for the manufacture of the supports;
(b) manufacturing the test part and observing, for each support, a collection of mechanical parameters pertaining to the support; and
(c) determining the additive manufacturing parameters for the manufacture of the support of the target part on a basis of the geometric parameters pertaining to the overhang of the target part and of the mechanical parameters pertaining to the support.

13. The method according to claim 12, wherein the additive manufacturing is performed by a consolidation source emitting a beam that successively consolidates layers of a pulverulent material, the collection of manufacturing parameters comprising at least one of the following parameters: a composition of the pulverulent material used, a speed of travel of a spot of the beam of the consolidation source, and an inter-vector space corresponding to a separation between two vectors of a path of the spot of the beam of the consolidation source.

14. The method according to claim 12, wherein the additive manufacturing is performed by a consolidation source emitting a beam that successively consolidates layers of a pulverulent material by total or partial melting.

15. The method according to claim 12, wherein the collection of mechanical parameters pertaining to the support comprises at least one of the following parameters: density, porosity, tensile-compressive strength, resistance to buckling, and bending strength.

16. The method according to claim 12, wherein the collection of geometric parameters pertaining to an overhang comprises at least one of the following parameters: altitude of an overhang, angle of an overhang with respect to a normal to a manufacturing plane, mass of the overhang, and surface area of the overhang.

17. The method according to claim 12, wherein step (b) comprises the manufacture of the test part exhibiting n similar pairs of first and second overhangs.

18. The method according to claim 12, wherein the collection of geometric parameters pertaining to the overhang for each support manufactured in step (a) comprises a variation in altitude.

19. The method according to claim 12, wherein step (c) comprises selecting a group of supports comprising at least one support that is neither broken nor bent.

20. The method according to claim 19, wherein the method is reiterated, on a basis of the selected group of supports, while varying the collection of geometric parameters pertaining to the overhang and/or the collection of manufacturing parameters pertaining to the supports.

21. The method according to claim 12, wherein step (c) comprises use of an optimization algorithm to select a best support on a basis of a collection of chosen manufacturing parameters and/or of a collection of chosen geometric parameters pertaining to the overhang.

22. A method for additive manufacturing of a support for a part having an overhang, where the support is manufactured according to manufacturing parameters determined by the step of (a) additively manufacturing a plurality of supports for each supporting an overhang of the test part, each support being associated with a collection of manufacturing parameters and a collection of geometric parameters pertaining to the overhang, step (a) comprising the following steps:
(a1) manufacturing, according to a collection of chosen manufacturing parameters, a support for supporting a first overhang of the test part, inclined at a first angle;
(a2) manufacturing, according to the collection of manufacturing parameters in step (a1), a second support for supporting a second overhang of the test part, inclined at a second angle different from the first angle; and
(a3) repeating steps (a1) and (a2) n times, where n>0 corresponds to the number of repeats, modifying n times the collection of parameters for the manufacture of the supports.
